(19) United States
(12) Patent Application Publication
(10) Pub. No.: US 2026/0074472 A1
(43) Pub. Date: Mar. 12, 2026

(54) POWER CABLE

(71) Applicant: JPC connectivity Inc., New Taipei City (TW)

(72) Inventors: Hsu-Feng CHANG, New Taipei City (TW); Zhen-Xiong SHUAI, New Taipei City (TW)

(21) Appl. No.: 18/936,967

(22) Filed: Nov. 4, 2024

(30) Foreign Application Priority Data
Sep. 11, 2024 (CN) 202422229291.3

(51) Int. Cl. H01R 24/30; H01B 7/02; H01B 9/00; H01R 13/40

(52) U.S. Cl. CPC H01R 24/30; H01B 7/02; H01B 9/003; H01B 9/006; H01R 13/40

(57) ABSTRACT

This disclosure is directed to a power cable having a connector, a first wire harness, a second wire harness and a limiting member. The connector has an insulative base, a first conductor and a second conductor. The first conductor and the second conductor are buried in the insulative base. The first wire harness has a first welding end, and the first welding end is connected to the first conductor. The second wire harness has a second welding end, and the second welding end is connected to the second conductor. The limiting member has a first limiting ring and a second limiting ring. The first limiting ring surrounds the first welding end, and the second limiting ring surrounds the second welding end.

### BACKGROUND OF THE DISCLOSURE

### Technical Field

The present disclosure relates to a connector and a cable assembly, particularly relates to a bus-clamped power cable used in servers, energy storage cabinets, etc.

### Description of Related Art

The bus-clamped connector and cable assembly is mainly used in electronic devices such as servers and energy storage cabinets, where the head end of the assembly is used to clamp a conductor board, and the tail end of the assembly is connected to a number of cables to transmit power. The bus-clamped connector used at the head end of the assembly clamps two clamping terminals opposite to each other.

In general, the wiring space inside the server or energy storage cabinet is limited, and the wiring path is long and not always straight, so the cable assembly with a curved wiring path inside the server or energy storage cabinet may easily lead to damages to the weld points due to excessive stress.

In view of the deficiencies of the related art, the present discloser conducted researches based on the existing technologies and the application of theories, and finally developed a power cable in accordance with the present disclosure to overcome the deficiencies of the related art.

### SUMMARY OF THE DISCLOSURE

The disclosure discloses a power cable, particularly a power cable with a wire harness limiting member.

The present disclosure provides a power cable, including a connector, a first wire harness, a second wire harness and a limiting member. The connector includes an insulative base, a first conductor and a second conductor, the first conductor and the second conductor are buried in the insulative base. The first wire harness includes a first welding end connected to the first conductor. The second wire harness includes a second welding end connected to the second conductor. The limiting member includes a first limiting ring and a second limiting ring, the first limiting ring surrounds the first welding end, and the second limiting ring surrounds the second welding end.

In an embodiment of the present disclosure, the first wire harness includes a first power line and a first insulation cladding covering the first power line, the first power line protrudes from the first insulation cladding at the first welding end and is welded to the first conductor, a first insulation sleeve sheathes on the junction between the first conductor and the first wire harness, and the first insulation sleeve covers the first welding end. The second wire harness includes a second power line and a second insulation cladding covering the second power line, the second power line protrudes from the second insulation cladding at the second welding end and is welded to the second conductor, a second insulation sleeve sheathes on the junction between the second conductor and the second wire harness, and the second insulation sleeve covers the second welding end.

In an embodiment of the present disclosure, the first limiting ring surrounds the first welding end and protrudes from the first insulation cladding, and the second limiting ring surrounds the second welding end and protruded from the second insulation cladding.

In an embodiment of the present disclosure, the power cable further includes a first signal terminal, a second signal terminal, a first signal line and a second signal line, the first signal terminal is arranged corresponding to the first conductor and buried in the insulative base, the second signal terminal is arranged corresponding to the second conductor and buried in the insulative base, the first signal line is connected to the first signal terminal, and the second signal line is connected to the second signal terminal.

In an embodiment of the present disclosure, the limiting member includes a bridge connected between the first limiting ring and the second limiting ring to make the first limiting ring and the second limiting ring to be spaced from each other, and the bridge has a plurality of clamps for clamping the first signal line and the second signal line respectively.

In an embodiment of the present disclosure, the power cable further includes a signal plug, and the first signal line and the second signal line are connected to the signal plug.

In an embodiment of the present disclosure, the power cable further includes a power plug connected to another end of the first wire harness and another end of the second wire harness.

In an embodiment of the present disclosure, the insulative base includes a first tongue and a second tongue, the first conductor includes a plurality of first power terminals, the second conductor includes a plurality of second power terminals, the first power terminals are buried in the first tongue, the second power terminals are buried in the second tongue, and the first power terminals and the second power terminals are arranged opposite to each other.

In an embodiment of the present disclosure, the power cable further includes a plurality of first shielding terminals and a plurality of second shielding terminals, the first shielding terminals and the first power terminals are arranged on two opposite sides of the first tongue respectively, and the second shielding terminals and the second power terminals are arranged on two opposite sides of the second tongue respectively.

In an embodiment of the present disclosure, the power cable further includes a first signal terminal and a second signal terminal, the first signal terminal is buried in the first tongue and arranged parallel to the first power terminals, and the second signal terminal is buried in the second tongue and arranged parallel to the second power terminals.

The power cable of the present disclosure has the limiting member surrounding the first wire harness and the second wire harness to achieve the supporting and limiting effects, so as to prevent the first wire harness and the second wire harness from being excessively bent and damaging the weld point.

### BRIEF DESCRIPTION OF THE DRAWINGS

FIG. 1 is a perspective view of a power cable in accordance with an embodiment of the present disclosure.

FIG. 2 is a schematic view showing the configuration of the connector of the power cable in accordance with an embodiment of the present disclosure.

FIG. 3 is a schematic view showing the configuration of another connector of the power cable in accordance with an embodiment of the present disclosure.

FIG. 4 is a schematic view showing the configuration of the first conductor and the second conductor of the connector of the power cable in accordance with an embodiment of the present disclosure.

FIG. 5 is a perspective view of the limiting member of the power cable in accordance with an embodiment of the present disclosure.

FIG. 6 is a longitudinal sectional view of the power cable in accordance with an embodiment of the present disclosure.

FIG. 7 is a transverse sectional view of the power cable in accordance with an embodiment of the present disclosure.

FIG. 8 is another transverse sectional view of the power cable in accordance with an embodiment of the present disclosure.

### DETAILED DESCRIPTION

In the description of this disclosure, it should be understood that the terms “front”, “rear”, “left”, “right”, “front end”, “rear end”, “longitudinal”, “transverse”, “vertical”, “top”, “bottom”, etc. indicate an orientation or positional relationship based on the orientation or positional relationship shown in the accompanying drawings. These terms are used for the purpose of describing the technical characteristics of this disclosure and simplifying the description, but not intended for indicating or implying that the device or component must have the specific orientation, positional structure and operation, so that these terms should not be construed as a limitation on this disclosure.

As used herein and not otherwise defined, the terms “substantially” and “approximately” are used to describe and refer to small changes. When combined with an event or circumstance, the term may encompass the precise moment of occurrence of the event or circumstance, as well as an approximation of the occurrence of the event or circumstance to a point of proximity. For example, when combined with a numeric value, the term may include a range of variation that is less than or equal to ±10% of the value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

The detailed description and technical contents of the present disclosure are illustrated with reference to the accompanying drawings, which are intended for the illustrative purposes only, but not intended for limiting the disclosure.

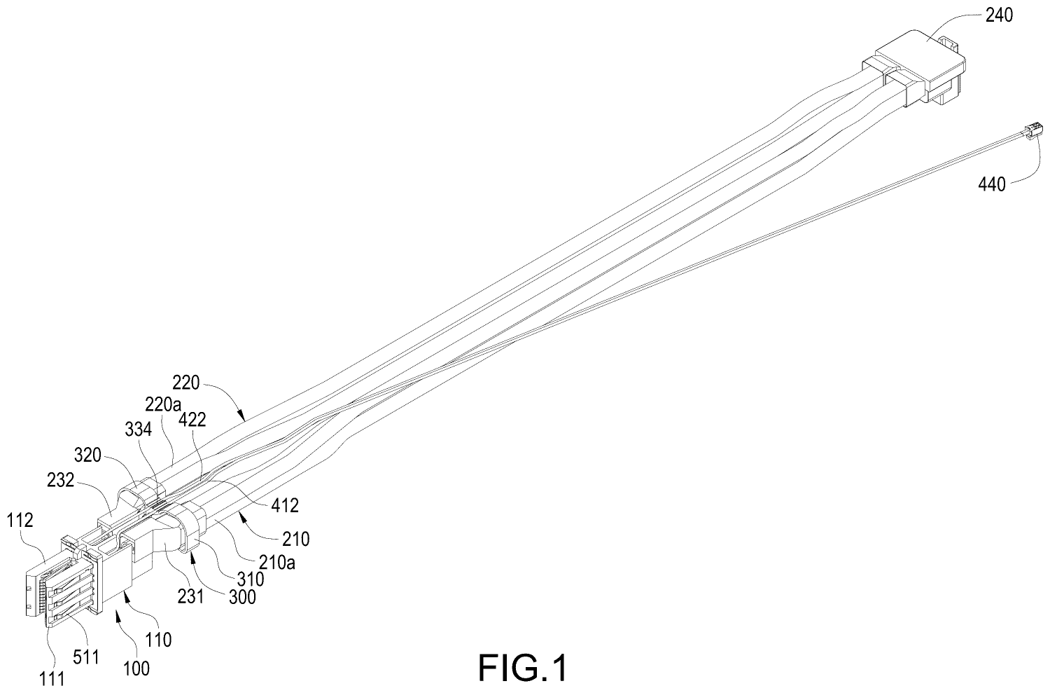

With reference to FIG. 1 for the schematic view of a power cable in accordance with an embodiment of the present disclosure, the power cable includes a connector 100, a first wire harness 210, a second wire harness 220 and a limiting member 300. The power cable of the present disclosure is applied to a main system inside a rack and connected between the main system and an external power supply to supply external power to the main system.

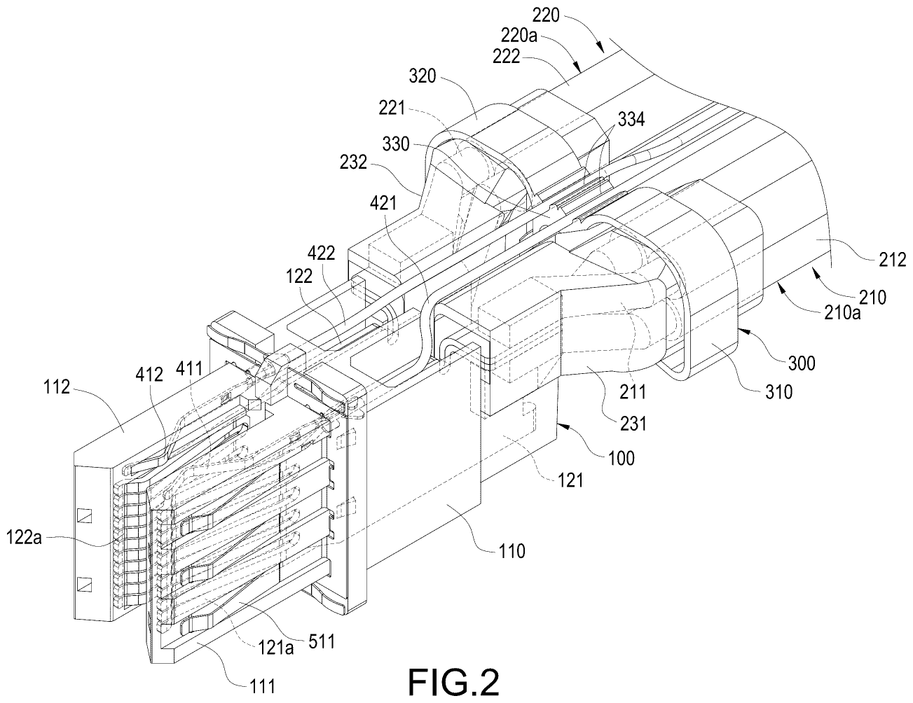

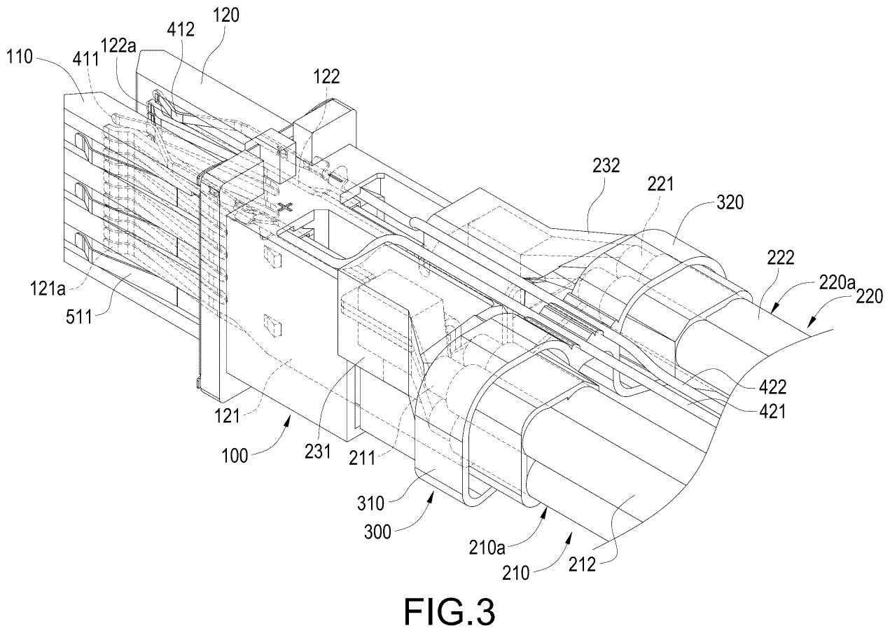

With reference to FIGS. 2 and 3 for the schematic views of two configurations of the connector 100 of the power cable in accordance with an embodiment of the present disclosure respectively, the connector 100 includes an insulative base 110, a first conductor 121 and a second conductor 122, and the first conductor 121 and the second conductor 122 are buried in the insulative base 110. In this embodiment, the insulative base 110 includes a first tongue 111 and a second tongue 112.

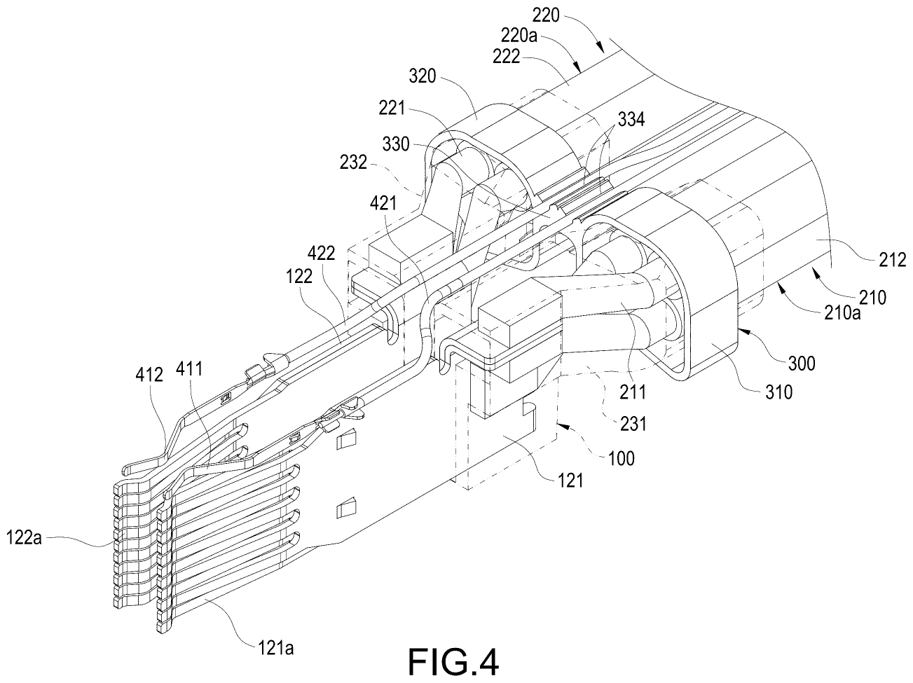

FIG. 4 is the schematic view of the configurations of the first conductor 121 and second conductor 122 of the connector 100 of the power cable in accordance with an embodiment of the present disclosure. With reference to FIGS. 2 to 4, the first conductor 121 includes a plurality of first power terminals 121a, the second conductor 122 includes a plurality of second power terminals 122a, the first power terminals 121a are buried in the first tongue 111, the second power terminals 122a are buried in the second tongue 112, and the first power terminals 121a and the second power terminals 122a are arranged opposite to each other.

The first wire harness 210 includes a first welding end 210a, and the first welding end 210a is connected to the first conductor 121. In some embodiments, the connection is made by ultrasonic welding, but the present disclosure is not limited to such arrangement. The first wire harness 210 includes at least one first power line 211 and a first insulation cladding 212 covering the first power line 211. In this embodiment, the first wire harness 210 is structured by three identical first power lines 211, each of which is covered with a first insulation cladding 212, but the present disclosure does not limit the quantity of first power lines 211 included in the first wire harness 210. In the following, one of the first power lines 211 is used as an example to illustrate the configuration of each first power line 211. The first power line 211 protrudes from the first insulation cladding 212 at a first welding end 210a of the first wire harness 210 to be welded to the first conductor 121. A first insulation sleeve 231 sheathes on the first conductor 121 where the first wire harnesses 210 are connected, and first insulation sleeve 231 covers each first welding end 210a.

The second wire harness 220 includes a second welding end 220a, and the second welding end 220a is connected to the second conductor 122. In an embodiment, the connection is made by ultrasonic welding, but the present disclosure is not limited to such arrangement. The second wire harness 220 includes at least one second power line 221 and the second power line 221 is covered with a second insulation cladding 222. In this embodiment, the second wire harness 220 is structured by three identical second power lines 221, each second power line 221 is covered with a second insulation cladding 222, but the present disclosure does not limit the quantity of second power lines 221 included in the second wire harness 220. In the following, one of the second power lines 221 is used as an example to illustrate the configuration of each second power line 221. The second power line 221 protrudes from the second insulation cladding 222 at the second welding end 220a of the second wire harness 220 to be welded to the second conductor 122. A second insulation sleeve 232 sheathes on the second conductor 122 where the second wire harnesses 220 are connected, and the second insulation sleeve 232 covers each second welding end 220a.

In this embodiment as shown in FIG. 1, the power cable further includes a power plug 240, and the power plug 240 is connected to another end of the first wire harness 210 and another end of the second wire harness 220. The power plug 240 is provided to be plugged to a main system. The first conductor 121 and the second conductor 122 are used as a positive electrode and a negative electrode of the DC power supply respectively, the first tongue 111 and the second tongue 112 are used to contact the first wire harness 210 and the second wire harness 220 with the conductive plate, so as to electrically connect the first power terminal 121a and the second power terminal 122a with a power source. Electric power is transmitted between the power plug 240 and the connector 100 by the first wire harness 210 and the second wire harness 220 to supply power to the main system.

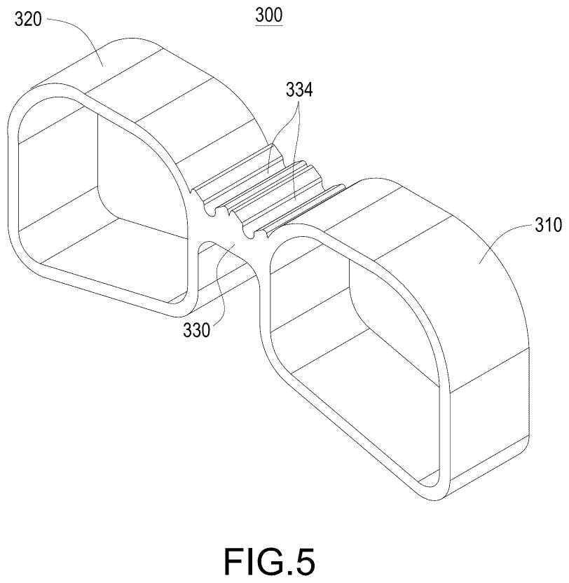

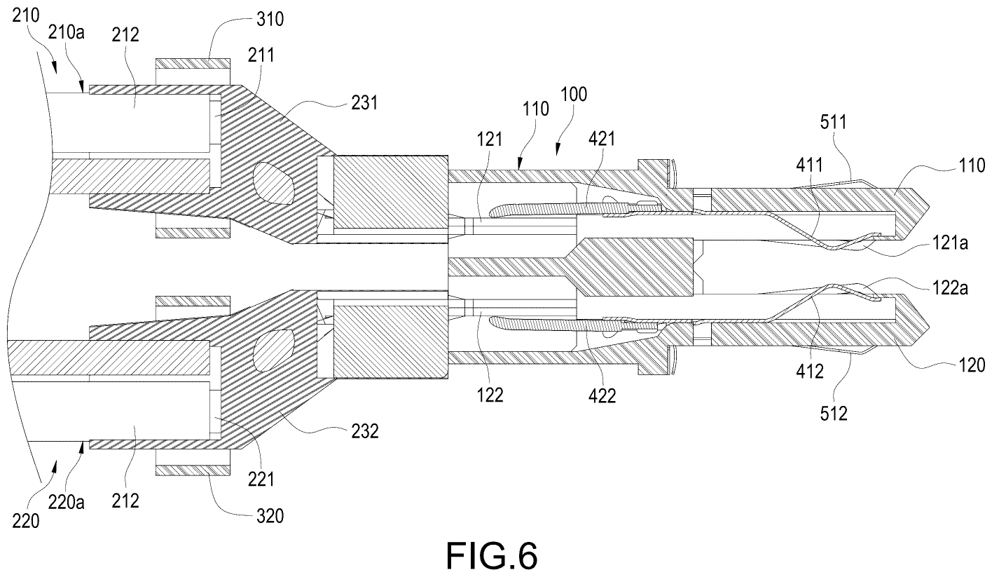

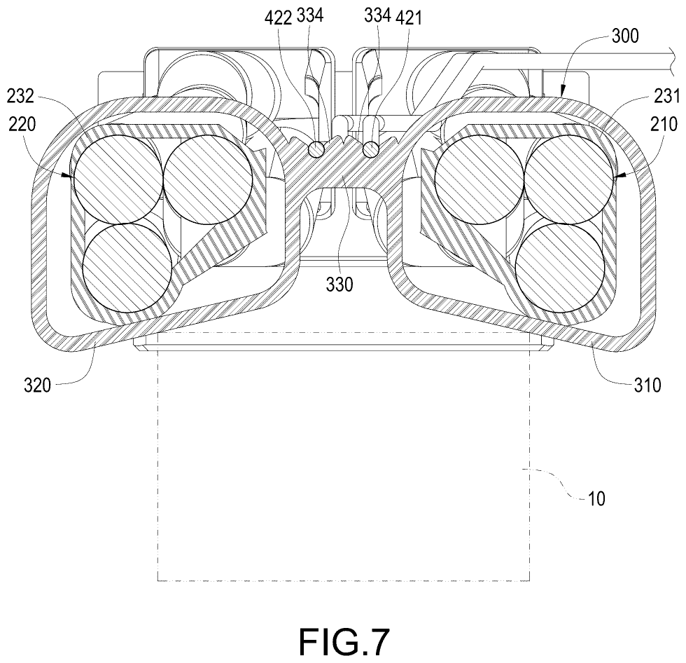

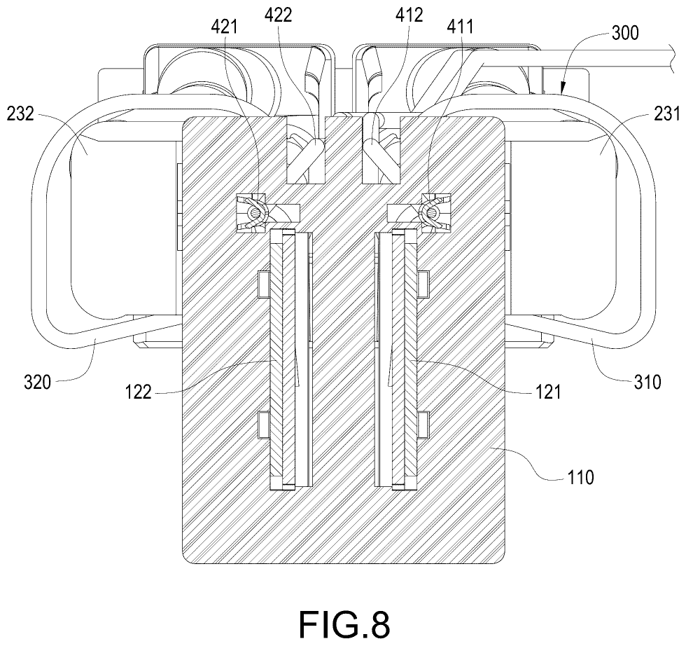

FIG. 5 is a perspective view of the limiting member 300 of the power cable in accordance with an embodiment of the present disclosure, FIG. 6 is a longitudinal cross-sectional view of the power cable of an embodiment of the present disclosure, FIG. 7 is a transverse cross-sectional view of the power cable of an embodiment of the present disclosure; and FIG. 8 is another transverse cross-sectional view of the power cable of an embodiment of the present disclosure.

In FIGS. 5 to 8, the limiting member 300 includes a first limiting ring 310 and a second limiting ring 320, the first limiting ring 310 surrounds the first welding end 210a, and the second limiting ring 320 surrounds the second welding end 220a, thereby the activity range of the first wire harness 210 and the second wire harness 220 being limited. In this embodiment, the limiting member 300 further includes a bridge 330 connected between the first limiting ring 310 and the second limiting ring 320, such that the first limiting ring 310 and the second limiting ring 320 are spaced from each other to position the relative positions of the first limiting ring 310 and the second limiting ring 320.

In specific embodiments as shown in FIGS. 2 to 4, the first limiting ring 310 surrounds the first welding end 210a at the position protruding from the first insulation cladding 212, and the inner edge of the first limiting ring 310 partially contacts the first insulation cladding 212, that is, the inner edge of the first limiting ring 310 is in contact with the bottom of the first insulation sleeve 231 to support the first wire harness 210 and protect the weld point. While allowing the first welding end 210a to swing within a limited range in coordination with the wiring, so as to avoid excessive bending. The second limiting ring 320 surrounds the second welding end 220a at the position protruding from the second insulation cladding 222, and the inner edge of the second limiting ring 320 partially contacts the second insulation cladding 222, that is, the inner edge of the second limiting ring 320 is in contact with the bottom of the second insulation sleeve 232 to support the second wire harness 220 and protect the weld point, while allowing the second welding end 220a to swing within a limited range in coordination with the wiring, so as to avoid excessive bending. The bottom of the limiting member 300 abuts the interior of the rack or an adjacent structure 10 on the main system to assist the supporting, so as to avoid the insulation cladding or the insulation sleeve from being worn out or losing the insulation effect due to its abutment against the adjacent structure 10.

In this embodiment as shown in FIGS. 2 to 4, the power cable further includes a first signal terminal 411, a second signal terminal 421, a first signal line 412 and a second signal line 422, the first signal terminal 411 is buried in the insulative base 110 corresponding to the first conductor 121, the second signal terminal 421 is buried in the insulative base 110 corresponding to the second conductor 122. In a specific embodiment, the first signal terminal 411 is buried in the first tongue 111 and arranged parallel to the first power terminals 121a, and the second signal terminal 421 is buried in the second tongue 112 and arranged parallel to the second power terminals 122a. The first signal line 412 is connected to the first signal terminal 411, and the second signal line 422 is connected to the second signal terminal 421. The bridge 330 is further provided with a plurality of clamps 334, and the clamps 334 clamp the first signal line 412 and the second signal line 422 respectively.

In this embodiment as shown in FIG. 1, the power cable further includes a signal plug 440, and the first signal line 412 and the second signal line 422 are connected to the signal plug 440. The signal plug 440 is plugged to the main system, such that the main system reads the power supply status of the first wire harness 210 and the second wire harness 220 through the first signal line 412 and the second signal line 422 and adjusts the power supply accordingly.

In this embodiment as shown in FIGS. 2 to 3 and 6, the power cable further includes a plurality of first shielding terminals 511 and a plurality of second shielding terminals 521, the first shielding terminals 511 and the first power terminals 121a are arranged on two opposite sides of the first tongue 111 respectively, and the second shielding terminals 521 and the second power terminals 122a are arranged on two opposite sides of the second tongue 112 respectively. The first shielding terminal 511 and the second shielding terminal 521 are grounded (such as touched with a grounding structure) to eliminate the electromagnetic interference to the first power terminal 121a and the second power terminal 122a.

The power cable of the present disclosure has the limiting member 300 surrounding the first wire harness 210 and the second wire harness 220 to achieve the supporting and limiting effect, so as to avoid the damages to the weld point by the excessive bending of the first wire harness 210 and the second wire harness 220.

While this disclosure has been described by means of specific embodiments which are not intended to limit the scope of the claims of this disclosure, numerous modifications and variations may be made thereto by those skilled in the art without departing from the scope and spirit of this disclosure set forth in the claims.

What is claimed is:

1. A power cable, comprising:
a connector, comprising an insulative base, a first conductor and a second conductor, and the first conductor and the second conductor buried in the insulative base;
a first wire harness, comprising a first welding end coupled to the first conductor;
a second wire harness, comprising a second welding end coupled to the second conductor; and
a limiting member, comprising a first limiting ring and a second limiting ring, the first limiting ring surrounding the first welding end, and the second limiting ring surrounding the second welding end.

2. The power cable of claim 1, wherein the first wire harness comprises a first power line and a first insulation cladding covering the first power line, the first power line protrudes out of the first insulation cladding from the first welding end and is welded to the first conductor, a first insulation sleeve sheathes a junction of the first conductor and the first wire harness, and the first insulation sleeve covers the first welding end; and
the second wire harness comprises a second power line and a second insulation cladding covers the second power line, the second power line protrudes out of the second insulation cladding from the second welding end and is welded to the second conductor, a second insulation sleeve sheathes a junction of the second conductor and the second wire harness, and the second insulation sleeve covers the second welding end.

3. The power cable of claim 2, wherein the first limiting ring surrounds the first welding end and protrudes from the first insulation cladding, and the second limiting ring surrounds the second welding end and protrudes from the second insulation cladding.

4. The power cable of claim 1, further comprising a first signal terminal, a second signal terminal, a first signal line and a second signal line, wherein the first signal terminal is arranged corresponding to the first conductor and buried in the insulative base, the second signal terminal is arranged corresponding to the second conductor and buried in the insulative base, the first signal line is coupled to the first signal terminal, and the second signal line is coupled to the second signal terminal.

5. The power cable of claim 4, wherein the limiting member comprises a bridge coupled between the first limiting ring and the second limiting ring to make the first limiting ring and the second limiting ring be a spaced apart from each other, and the bridge comprising a plurality of clamps for clamping the first signal line and the second signal line respectively.

6. The power cable of claim 4, further comprising a signal plug, and the first signal line and the second signal line coupled to the signal plug.

7. The power cable of claim 1, further comprising a power plug, and the power plug coupled to another end of the first wire harness and another end of the second wire harness respectively.

8. The power cable of claim 1, wherein the insulative base comprises a first tongue and a second tongue, the first conductor comprises a plurality of first power terminals, the second conductor comprises a plurality of second power terminals, the first power terminals are buried in the first tongue, the second power terminals are buried in the second tongue, and the first power terminals and the second power terminals are arranged opposite to each other.

9. The power cable of claim 8, further comprising a plurality of first shielding terminals and a plurality of second shielding terminals, wherein the first shielding terminals and the first power terminals are arranged on two sides of the first tongue opposite to each other, the second shielding terminals and the second power terminals are arranged on two sides of the second tongue opposite to each other.

10. The power cable of claim 8, further comprising a first signal terminal and a second signal terminal, the first signal terminal being buried in the first tongue and arranged parallel to the first power terminals, and the second signal terminal being buried in the second tongue and arranged parallel to the second power terminals.
